(19) United States
(12) Patent Application Publication
(10) Pub. No.: US 2013/0234923 A1
(43) Pub. Date: Sep. 12, 2013

(54) DRIVING DEVICE OF IMAGE DISPLAY MEDIUM, IMAGE DISPLAY APPARATUS, DRIVING METHOD OF IMAGE DISPLAY MEDIUM, AND NON-TRANSITORY COMPUTER READABLE MEDIUM

(71) Applicant: FUJI XEROX CO., LTD., Tokyo (JP)

(72) Inventors: Yoshinori MACHIDA, Kanagawa (JP); Masaaki ABE, Kanagawa (JP); Yasufumi SUWABE, Kanagawa (JP)

(73) Assignee: FUJI XEROX CO., LTD., Tokyo (JP)

(21) Appl. No.: 13/656,228

(22) Filed: Oct. 19, 2012

(30) Foreign Application Priority Data
Mar. 9, 2012 (JP) 2012-053315

(51) Int. Cl. G09G 3/34

(52) U.S. Cl. 345/107

(57) ABSTRACT

A driving device of an image display medium includes a voltage applying unit that applies a voltage between substrates, a generation unit that generates a polarity pattern where a polarity is reversed at a time width shorter than a pulse width at which a colored particle, of which pulse width for displaying the maximum density is the shortest, displays the maximum density, and a controller that controls the voltage applying unit such that a voltage with the magnitude for driving each kind of the colored particles is applied to each pixel, the voltage being a voltage with the same polarity continuously selected for each kind of colored particle, and the voltage with the same polarity being selected from voltages of which polarities are reversed in the polarity pattern on the basis of information on each pixel of the image information.

### CROSS-REFERENCE TO RELATED APPLICATIONS

This application is based on and claims priority under 35 USC 119 from Japanese Patent Application No. 2012-053315 filed Mar. 9, 2012.

### BACKGROUND

(i) Technical Field

The present invention relates to a driving device of an image display medium, an image display apparatus, a driving method of an image display medium, and a non-transitory computer readable medium.

(ii) Related Art

In the related art, as an image display medium which has a memory property and may be repeatedly updated, an image display medium using a colored particle is known. The image display medium includes, for example, a pair of substrates and plural kinds of particle groups which are sealed between the substrates so as to be movable between the substrates due to an electric field applied to the pair of substrates and have different colors and charge characteristics.

In this image display medium, particles are moved by applying a voltage corresponding to an image between a pair of substrates, and the image is displayed as a contrast of particles of different colors. In addition, even after a voltage stops being applied after the image is displayed, the particles are continuously attached to the substrates by a Van der Waals' force or a mirror image force, and the image display is maintained.

Further, as an image display medium having a memory property, in addition to an image display device using a colored particle, for example, there is a liquid crystal display device having a memory property, an image display device using electrochromism, or the like.

### SUMMARY

According to an aspect of the invention, there is provided a driving device of an image display medium which includes plural of kinds of colored particles having different charge characteristics for every kind and different colors for every kind for each pixel between a pair of substrates either of which has transparency and which displays an image by applying a voltage between the pair of substrates on the basis of image information, the driving device including a voltage applying unit that applies a voltage between the substrates; a generation unit that generates a polarity pattern in which a polarity is reversed at a time width shorter than a pulse width at which a colored particle, of which pulse width for displaying the maximum density is the shortest among the plural kinds of colored particles, displays the maximum density; and a controller that controls the voltage applying unit such that a voltage with the magnitude for driving each kind of the colored particles is applied to each pixel, the voltage being a voltage with the same polarity continuously selected in the polarity pattern generated by the generation unit for each kind of colored particle, and the voltage with the same polarity being selected from voltages of which polarities are reversed in the polarity pattern on the basis of information on each pixel of the image information.

### BRIEF DESCRIPTION OF THE DRAWINGS

Exemplary embodiments of the present invention will be described in detail based on the following figures, wherein:

FIG. 1A is a diagram illustrating a schematic configuration of an image display apparatus according to a first exemplary embodiment of the invention;

FIG. 1B is a block diagram illustrating a schematic configuration of a controller;

FIG. 2A is a diagram illustrating a configuration of a voltage applying unit employing an active matrix type;

FIG. 2B is a diagram illustrating a configuration of a voltage applying unit employing a passive matrix type;

FIG. 3A is a diagram illustrating a driving method of an image display apparatus in the related art;

FIG. 3B is a diagram illustrating a driving method of the image display apparatus according to the first exemplary embodiment of the invention;

FIGS. 4A to 4D are diagrams illustrating another example of the driving method of the image display apparatus according to the first exemplary embodiment of the invention;

FIGS. 5A and 5B are diagrams illustrating a schematic configuration of an image display apparatus according to a second exemplary embodiment of the invention;

FIG. 6 is a diagram illustrating threshold value characteristics in the image display apparatus according to the second exemplary embodiment of the invention;

FIGS. 7A to 7H are diagrams illustrating an example of the driving control of the image display apparatus according to the second exemplary embodiment of the invention;

FIGS. 8A to 8D are diagrams illustrating a driving method of an image display apparatus in the related art (A and B), and illustrating a driving method of the image display apparatus according to the second exemplary embodiment of the invention (C and D); and

FIGS. 9A to 9D are diagrams illustrating another example of the driving method of the image display apparatus in the related art (A and B), and illustrating another example of the driving method of the image display apparatus according to the second exemplary embodiment of the invention (C and D).

### DETAILED DESCRIPTION

Hereinafter, exemplary embodiments of the invention will be described with reference to the drawings. The members having the same operation or function are given the same reference numerals through the overall drawings, and repeated description is omitted in some cases. In addition, for simplicity of description, the exemplary embodiment will be described with reference to the figures in which attention is paid to an appropriate single cell. Further, in the following description, a “memory property” indicates a performance which maintains an image display state.

### First Exemplary Embodiment

The exemplary embodiment shows an example including a white-colored particle and a black-colored particle. In addition, the white-colored particle is indicated by a white particle W, the black-colored particle is indicated by a black particle K, and each particle and a particle group thereof are indicated by the same symbol (reference numeral).

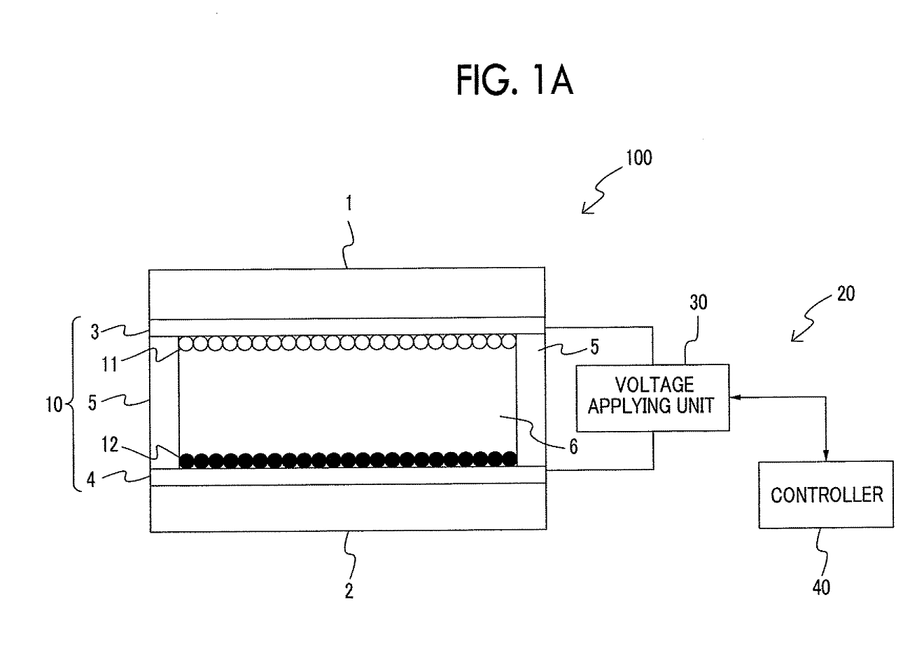

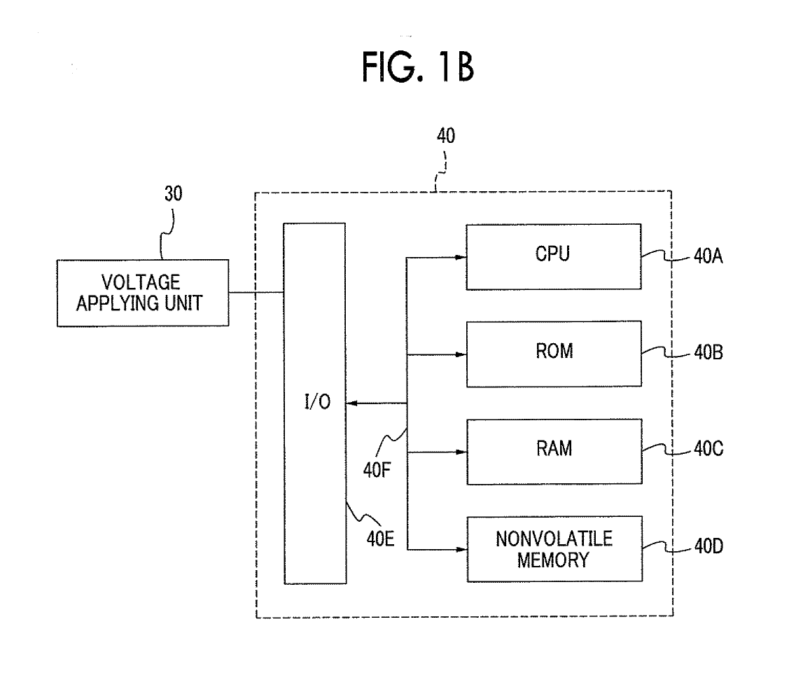

FIG. 1A is a diagram illustrating a schematic configuration of an image display apparatus according to the first exemplary embodiment of the invention. The image display apparatus 100 includes an image display medium 10 and a driving device 20 which drives the image display medium 10. The driving device 20 includes a voltage applying unit 30 which applies a voltage between a display side electrode 3 and a back surface side electrode 4 of the image display medium 10, and a controller 40 which controls the voltage applying unit 30 according to image information of an image displayed on the image display medium 10.

The image display medium 10 has a pair of substrates in which a transparent display substrate 1 which is an image display surface and a back surface substrate 2 which is a non-display surface are disposed so as to be opposite to each other with a gap.

A gap member 5 which holds the substrates 1 and 2 in a defined gap and partitions a space between the substrates into plural cells is provided.

The cell indicates a region surrounded by the back surface substrate 2 provided with the back surface side electrode 4, the display substrate 1 provided with the display side electrode 3, and the gap member 5. In the cell, for example, a dispersion medium 6 constituted by an insulating liquid, and a first particle group 11 and a second particle group 12 dispersed in the dispersion medium 6 are sealed.

The first particle group 11 and the second particle group 12 have different colors and charge polarities, and there are characteristics that the first particle group 11 and the second particle group 12 respectively migrate in an opposite direction by applying a voltage which is equal to or more than a predefined threshold value between a pair of electrodes 3 and 4.

In the exemplary embodiment, a description will be made of an example where the first particle group 11 is a white particle W charged with a positive polarity and the second particle group 12 is a black particle K charged with a negative polarity.

In addition, threshold value characteristics where the first particle group 11 and the second particle group 12 are moved by an electric field may be different, and a color different from colors of the migrating particles may be displayed by mixing the dispersion medium with a colorant.

The driving device 20 (the voltage applying unit 30 and the controller 40) applies a voltage corresponding to a color displayed between the display side electrode 3 and the back surface side electrode 4 of the image display medium 10 such that the particle groups 11 and 12 migrate and thereby are pulled to either of the display substrate 1 and the back surface substrate 2 according to a charged polarity of each of them.

The voltage applying unit 30 is electrically connected to the display side electrode 3 and the back surface side electrode 4. In addition, the voltage applying unit 30 is connected to the controller 40 such that a signal is sent and received therebetween.

The controller 40 includes, for example, a computer 40 as illustrated in FIG. 1B. In addition, in the exemplary embodiment, the controller 40 also has a role of a generation unit which generates a polarity pattern of a voltage. The computer 40 includes, for example, a Central Processing Unit (CPU) 40A, a Read Only Memory (ROM) 40B, a Random Access Memory (RAM) 40C, a nonvolatile memory 40D, and an input and output interface (I/O) 40E, which are connected to each other via a bus 40F, and the I/O 40E is connected to the voltage applying unit 30. In this case, a program causing the computer 40 to execute a process for generating a voltage polarity pattern for the image display medium and a process for instructing the voltage applying unit 30 to apply a voltage necessary for display of each color is written in, for example, the nonvolatile memory 40D, and the CPU 40A reads and executes the program. In addition, the program may be provided using a recording medium such as a CD-ROM.

The voltage applying unit 30 is a voltage applying device for applying a voltage to the display side electrode 3 and the back surface side electrode 4, and applies a voltage responding to the control of the controller 40 to the display side electrode 3 and the back surface side electrode 4. The voltage applying unit 30 may employ an active matrix type or a passive matrix type. Alternatively, a segment type may be employed.

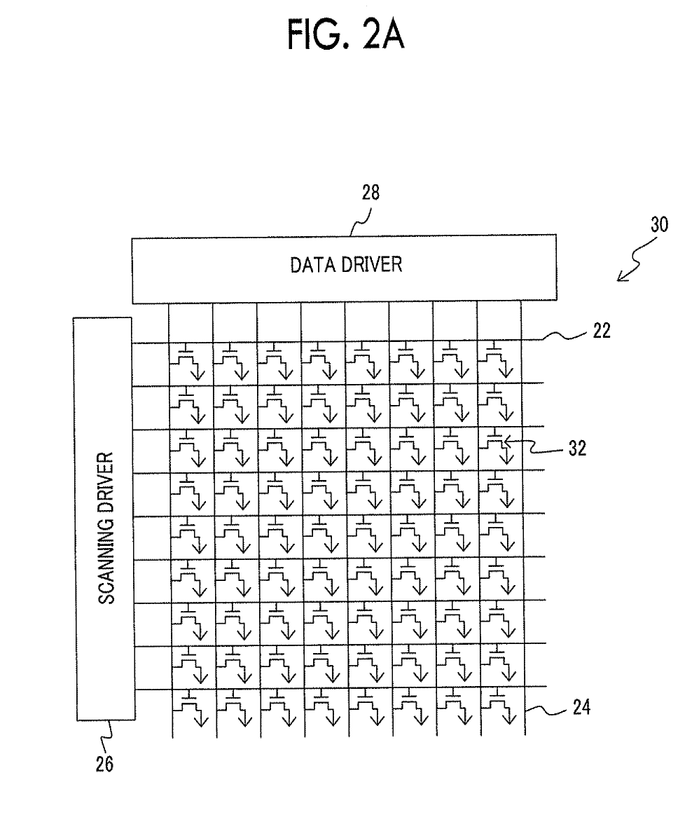

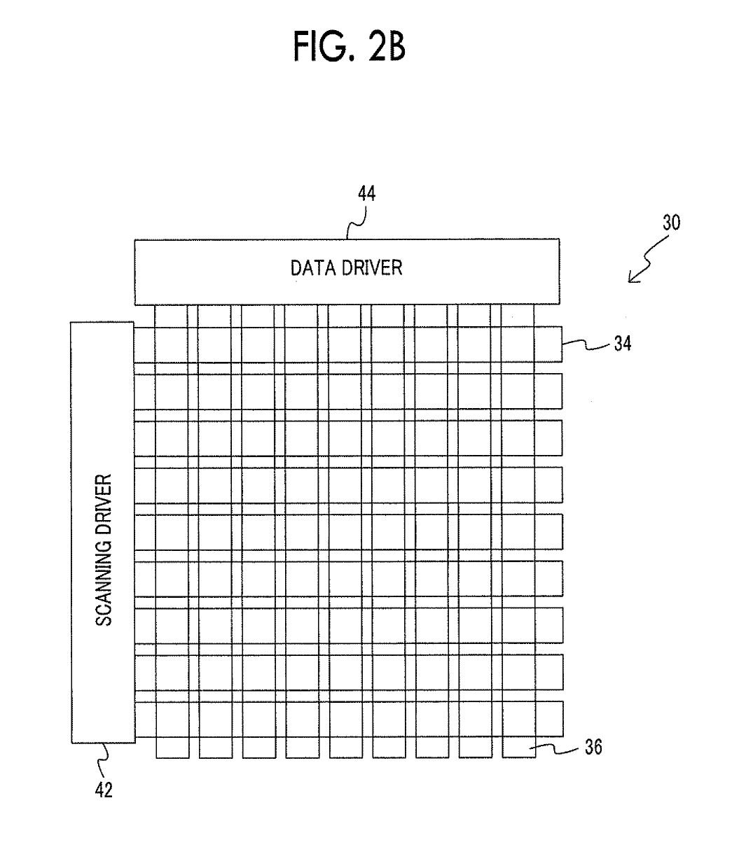

FIG. 2A illustrates a configuration of the voltage applying unit 30 employing the active matrix type, and FIG. 2B illustrates a configuration of the voltage applying unit 30 employing the passive matrix type.

In a case of the active matrix type, as illustrated in FIG. 2A, plural scanning lines 22 and plural signal lines 24 are disposed in a matrix. The scanning lines 22 are connected to a scanning driver 26, and the signal lines 24 are connected to a data driver 28.

In addition, thin film transistors (TFTs) 32 and an electrode (the back surface side electrode 4 in the exemplary embodiment) are provided at the intersections of the scanning lines 22 and the signal lines 24. Specifically, the scanning lines 22 are connected to gates of the thin film transistors, the back surface side electrode 4 is connected to drains thereof, and the data driver 28 is connected to sources thereof. In addition, the above-described colored particles (the first particle group 11 and the second particle group 12) are sealed between the back surface side electrode 4 and the display side electrode 3.

That is to say, the thin film transistors 32 disposed in a matrix are sequentially selected by controlling the scanning driver 26 and the data driver 28, and an image is displayed by applying a voltage corresponding to image information to the back surface side electrode 4. In addition, in a case of changing the magnitude of a voltage, the magnitude of a voltage applied between the substrates may be changed by changing a source voltage supplied from the data driver 28.

On the other hand, in a case of the passive matrix type, plural strip-shaped scanning electrodes 34 and signal electrodes 36 are disposed in a matrix. The scanning electrodes 34 are connected to a scanning driver 42, the signal electrodes 36 are connected to a data driver 44, and each intersection therebetween forms a pixel. For example, if the scanning electrode 34 is used as the back surface side electrode 4, and the signal electrode 36 is used as the display side electrode 3, the scanning driver 42 and the data driver 44 are controlled so as to apply a voltage between the substrates, thereby displaying an image.

In addition, in the exemplary embodiment, as an example, a case of employing the active matrix type will be described. In addition, in the following description, as an example, a case where the display side electrode 3 is grounded, and a voltage is applied to the back surface side electrode 4 will be described.

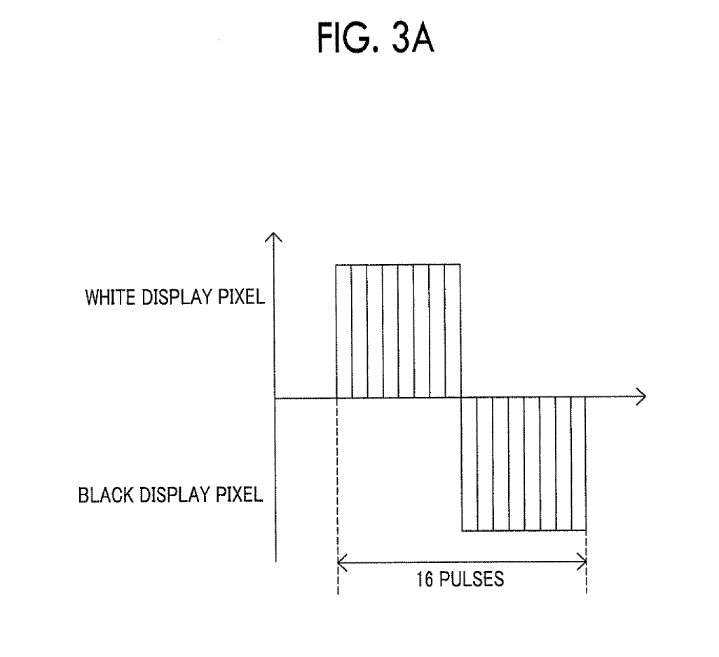

When the image display medium 10 configured in this way is driven, as illustrated in FIG. 3A, in the related art, a positive voltage is applied to the back surface side electrode 4 so as to move the white particles W in all the pixels to the display substrate 1 (in a reset state), and a negative voltage is applied to the back surface side electrode 4 with respect to pixels performing black display so as to move the black particles K to the display substrate 1. In addition, in order to obtain the necessary densities, a predetermined number of pulse voltages with a predefined pulse width are applied (eight pulses in the example of FIG. 3A) (or a pulse voltage with a pulse width corresponding to a necessary density is applied).

More specifically, the scanning driver 26 and the data driver 28 are controlled so as to apply a positive pulse voltage with predefined magnitude and width by turning on the thin film transistors 32 corresponding to all the pixels. At this time, the scanning driver 26 and the data driver 28 are controlled so as to apply the number of pulse voltages corresponding to image information. Successively, the scanning driver 26 and the data driver 28 are controlled so as to apply a negative pulse voltage with predefined magnitude and width by turning on the thin film transistors 32 corresponding to the pixels performing black display. At this time, similarly, the scanning driver 26 and the data driver 28 are controlled so as to apply the number of pulse voltages corresponding to image information. Thereby, an image may be displayed.

Here, it is assumed that the number of pulses where black display and white display respectively become the maximum densities is eight pulses. The human being begins to recognize an approximate image if about a half of the density of the display state is displayed. Therefore, in a case where the number of pulses indicating the maximum density is eight pulses, an image may be recognized if pulses for displaying an image are approximately four pulses.

However, in the related art, an image may not be displayed unless black display is performed after performing white display. Therefore, the time until an image may be recognized requires about twelve pulses, with the eight pulses necessary for white display and the four pulses necessary for black display in the example of FIG. 3A.

Therefore, in the exemplary embodiment, a voltage polarity pattern where a polarity is reversed at a time width shorter than a pulse width of a colored particle of which the pulse width for displaying the maximum density is the shortest is generated, and the voltage applying unit 30 (the scanning driver 26 and the data driver 28) is controlled such that a voltage with the same polarity of voltages of which polarities are reversed in the generated polarity pattern is continuously selected for each kind of colored particle on the basis of information on each pixel of image information, and a voltage with a magnitude for driving each kind of colored particle is applied to each pixel. Specifically, the controller 40 controls the scanning driver 26 and the data driver 28 of the voltage applying unit 30 such that a positive pulse voltage with a pulse width shorter than the pulse width for displaying the maximum density and a negative pulse voltage with the corresponding pulse width are alternately scanned, the thin film transistors 32 are turned on at the timing when the positive pulse voltage is scanned in the pixels corresponding to white display, the thin film transistors 32 are turned on at the timing when the negative pulse voltage is scanned in the pixels corresponding to black display, and the necessary number of pulse voltages are repeatedly applied until a density corresponding to image information arrives.

Thereby, as illustrated in FIG. 3B, since the pulse voltages are alternately applied to the black display pixels and the white display pixels, the density is relatively varied, and thus an image is recognized faster than in the display method in the related art in which black display is performed after performing white display, or white display is performed after performing black display.

More specifically, as illustrated in FIG. 3B, the data driver 28 alternately applies a positive pulse voltage and a negative pulse voltage, and the scanning driver 26 turns on and off the thin film transistors 32 so as to repeat the number of times indicated by each piece of image information by turning on the thin film transistors 32 at the timing when the positive pulse voltage is applied to the white display pixels and by turning on the thin film transistors 32 at the timing when the negative pulse voltage is applied to the black display pixels. With this driving, in the example of FIG. 3B, a relative density variation is considerably shown at about a half (for example, eight pulses) of the number of pulses in FIG. 3A, and thus time when an image may be recognized is faster than i the related art by approximately four pulses. In other words, since the time for when a display density of each particle becomes a half is faster than in the related art, it is expected that the time to reach a state where an image may be recognized is reduced.

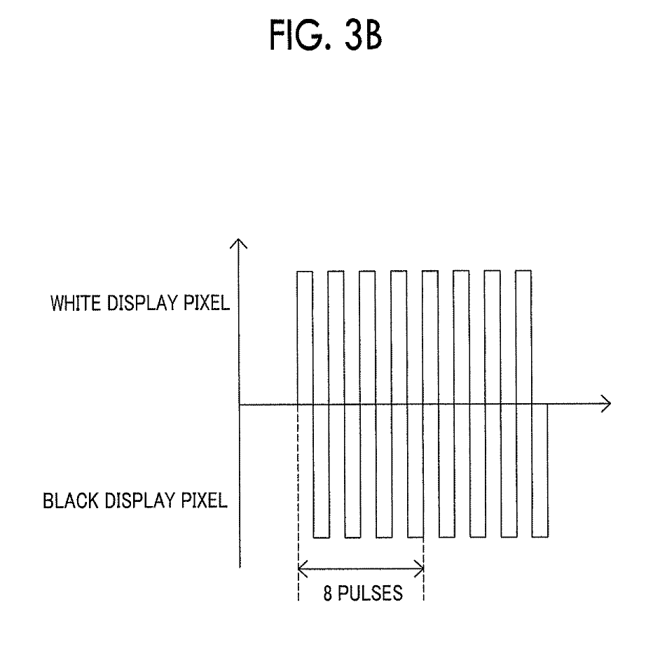

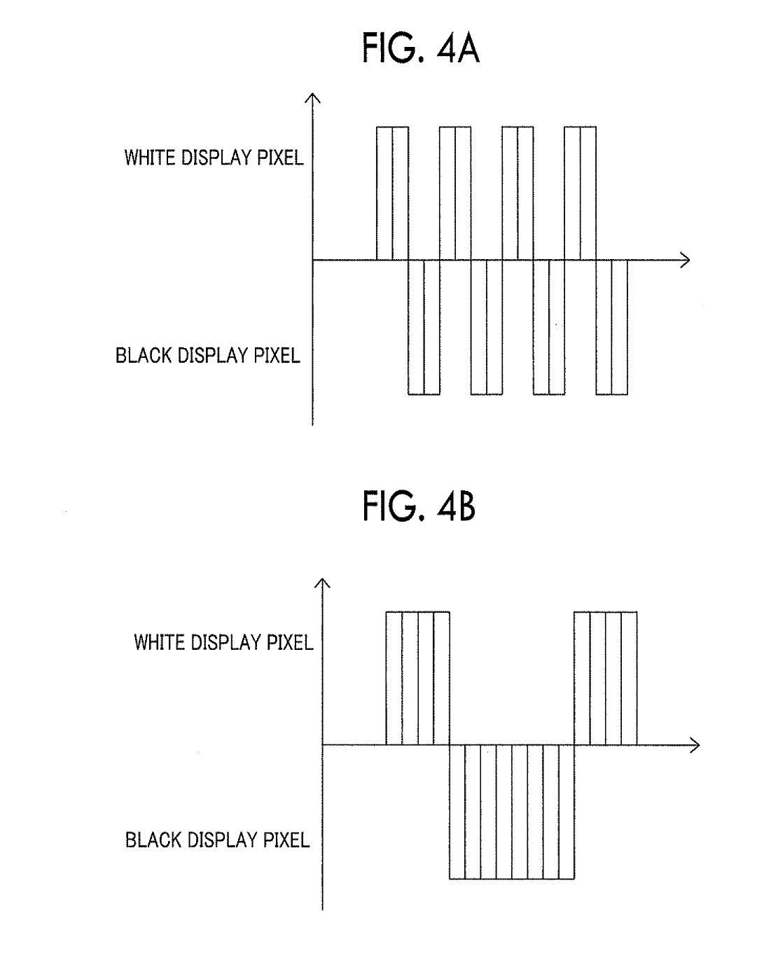

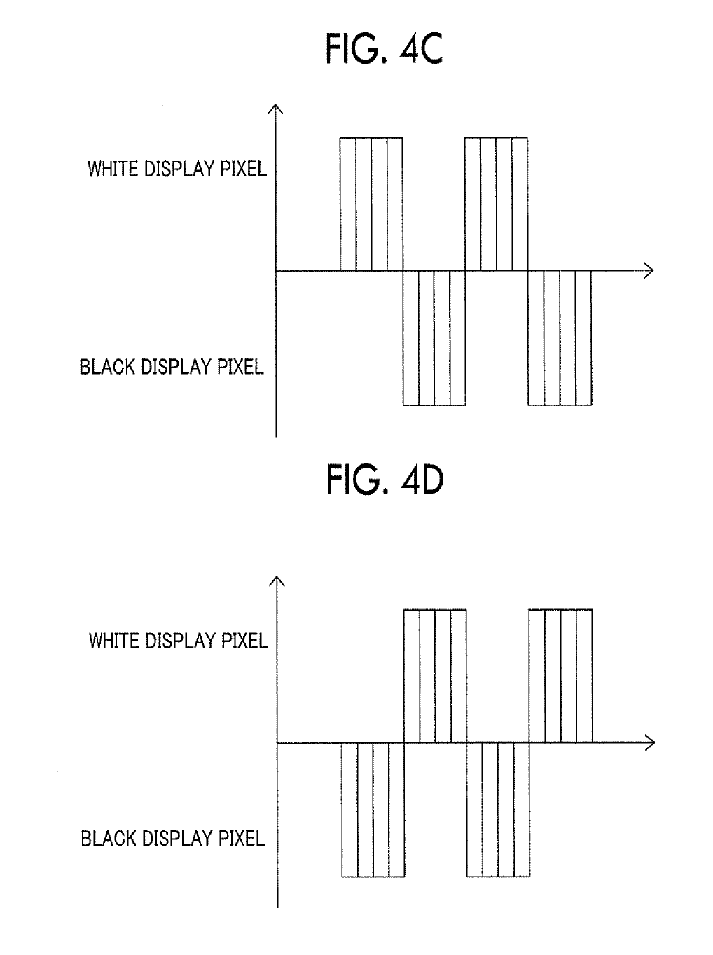

In addition, although, in the above-described exemplary embodiment, an example where a positive pulse voltage and a negative pulse voltage are alternately applied every pulse is described, the invention is not limited thereto, and, for example, voltages may be applied as illustrated in FIGS. 4A to 4D. FIG. 4A illustrates an example where a positive pulse voltage and a negative pulse voltage are alternately applied every two pulses, FIG. 4B illustrates an example where a positive pulse voltage of four pulses, a negative pulse voltage of eight pulses, and the positive pulse voltage of four pulses are applied, FIG. 4C illustrates an example where a positive pulse voltage and a negative pulse voltage are alternately applied every four pulses, and FIG. 4D illustrates an example where a negative pulse voltage is first applied reversely to FIG. 4C.

### Second Exemplary Embodiment

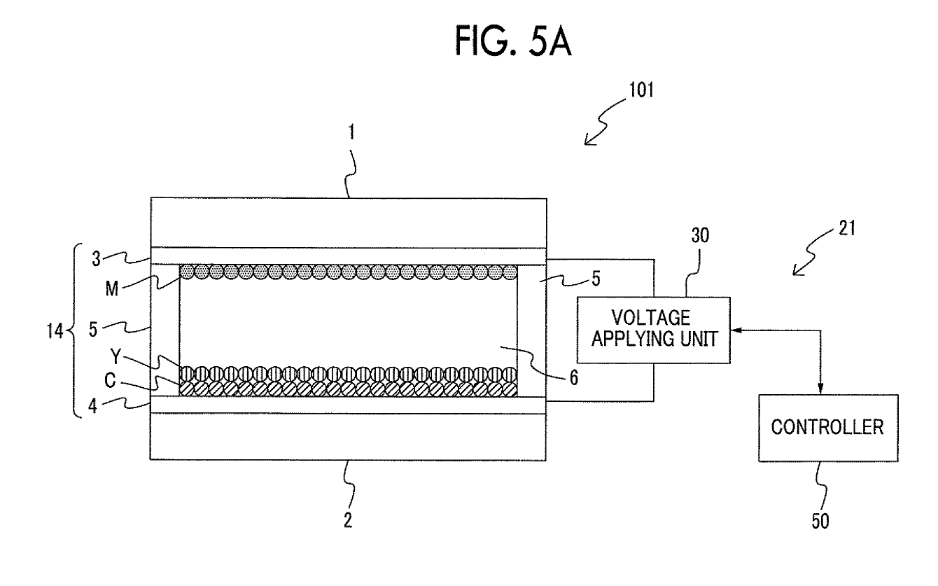

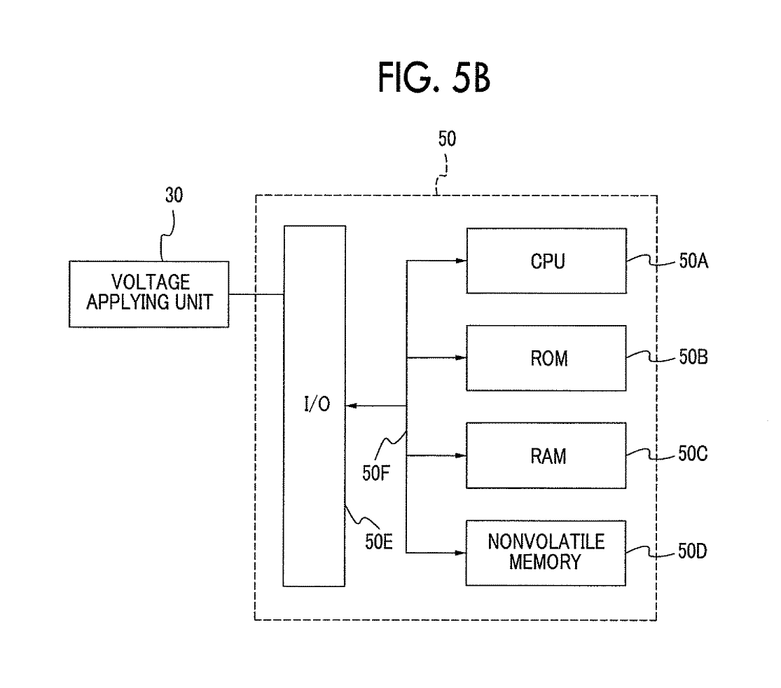

Next, an image display apparatus according to the second exemplary embodiment of the invention will be described. FIGS. 5A and 5B are diagrams illustrating a schematic configuration of the image display apparatus according to the second exemplary embodiment of the invention.

Although an example where two kinds of colored particles, white particle W and black particle K are provided has been described in the first exemplary embodiment, in the second exemplary embodiment, a yellow-colored particle, a cyan-colored particle, and a magenta-colored particle are provided, and a dispersion medium is colored white through mixing with a colorant. In addition, the yellow-colored particle is indicated by a yellow particle Y, the cyan-colored particle is indicated by a cyan particle C, and the magenta-colored particle is indicated by a magenta particle M. In addition, each particle and a particle group thereof are indicated by the same symbol (reference numeral). The same constituent elements as in the first exemplary embodiment are given the same reference numerals.

An image display apparatus 101 according to the second exemplary embodiment also includes an image display medium 14, and a driving device 21 driving the image display medium 14. The driving device 21 includes a voltage applying unit 30 which applies a voltage between a display side electrode 3 and a back surface side electrode 4 of the image display medium 14, and a controller 50 which controls the voltage applying unit 30 according to image information of an image displayed on the image display medium 14.

The image display medium 14 has a pair of substrates in which a transparent display substrate 1 which is an image display surface and a back surface substrate 2 which is a non-display surface are disposed so as to be opposite to each other with a gap.

A gap member 5 which holds the substrates 1 and 2 in a defined gap and partitions a space between the substrates into plural cells is provided.

The cell indicates a region surrounded by the back surface substrate 2 provided with the back surface side electrode 4, the display substrate 1 provided with the display side electrode 3, and the gap member 5. In the cell, for example, a dispersion medium 6 constituted by an insulating liquid, and a yellow particle group Y, a cyan particle group C, and a magenta particle group M dispersed in the dispersion medium 6 are sealed. In addition, in the following, the respective particle groups are referred to as a yellow particle Y, a cyan particle C, and a magenta particle M in some cases.

The respective particle groups have different colors and threshold value characteristics of being moved depending on an electric field, and have characteristics that the particle groups respectively migrate independently by applying a voltage which is equal to or more than a predefined threshold value between a pair of electrodes 3 and 4.

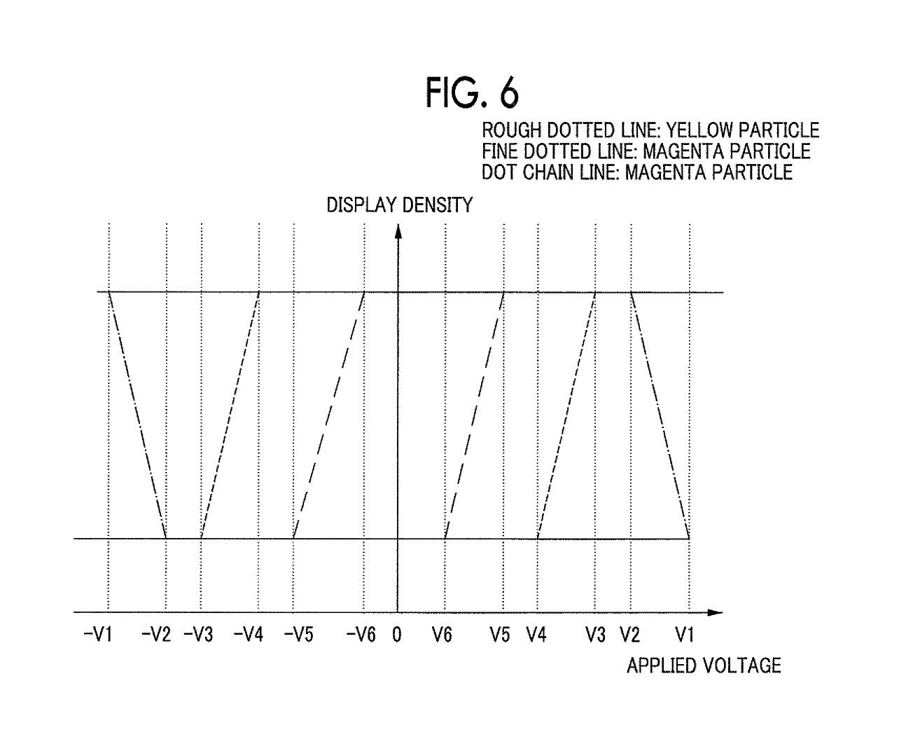

The threshold value characteristics of the particle groups are illustrated in FIG. 6, and, in the exemplary embodiment, a description will be made of an example where the yellow particle Y and the cyan particle C are charged with a positive polarity, and the magenta particle M is charged with a negative polarity.

Specifically, as illustrated in FIG. 6, a voltage range required to move the yellow particle Y is set to |V6≦V≦V5| (an absolute value between V6 and V5), a voltage range required to move the cyan particle C is set to |V4≦V≦V4| (an absolute value between V4 and V3), and a voltage range required to move the magenta particle M is set to |V2≦V≦V1| (an absolute value between V2 and V1). The different voltage ranges are set such that the voltage ranges required to move the particles do not overlap each other. That is to say, the yellow particle Y, the cyan particle C, and the magenta particle M have different charge characteristics.

The driving device 21 (the voltage applying unit 30 and the controller 50) applies a voltage corresponding to a color displayed between the display side electrode 3 and the back surface side electrode 4 of the image display medium 14 such that the particle groups migrate and thereby are pulled to either of the display substrate 1 and the back surface substrate 2 according to the charged polarity of each of them in the same manner as the first exemplary embodiment.

The voltage applying unit 30 is electrically connected to the display side electrode 3 and the back surface side electrode 4. In addition, the voltage applying unit 30 is connected to the controller 50 such that a signal is sent and received therebetween.

The controller 50 includes, for example, a computer 50 as illustrated in FIG. 58. The computer 50 includes, for example, a Central Processing Unit (CPU) 50A, a Read Only Memory (ROM) 50B, a Random Access Memory (RAM) 50C, a nonvolatile memory 50D, and an input and output interface (I/O) 50E, which are connected to each other via a bus 50F, and the I/O 50E is connected to the voltage applying unit 30. In this case, a program causing the computer 50 to execute a process for instructing the voltage applying unit 30 to apply a voltage necessary for display of each color is written in, for example, the nonvolatile memory 50D, and the CPU 50A reads and executes the program. In addition, the program may be provided using a recording medium such as a CD-ROM.

The voltage applying unit 30 is a voltage applying device for applying a voltage to the display side electrode 3 and the back surface side electrode 4, and applies a voltage responding to the control of the controller 50 to the display side electrode 3 and the back surface side electrode 4.

As described in the first exemplary embodiment, the voltage applying unit 30 may employ an active matrix type, a passive matrix type, or a segment type, and, in the exemplary embodiment, as an example, a case of employing the active matrix type will be described. In addition, in the following description, as an example, a case where the display side electrode 3 is grounded, and a voltage is applied to the back surface side electrode 4 will be described. Further, configurations of the active matrix type and the passive matrix type are the same as those described in the first exemplary embodiment, and thus a detailed description will be omitted.

Next, an example of the driving control of the image display apparatus with the above-described configuration according to the second exemplary embodiment of the invention will be described. In addition, in the following, as described above, a case where the display side electrode 3 is grounded, and a voltage is applied to the back surface side electrode 4 will be described. Further, in the following, for simplicity of description, the description will be made by paying attention to a single pixel.

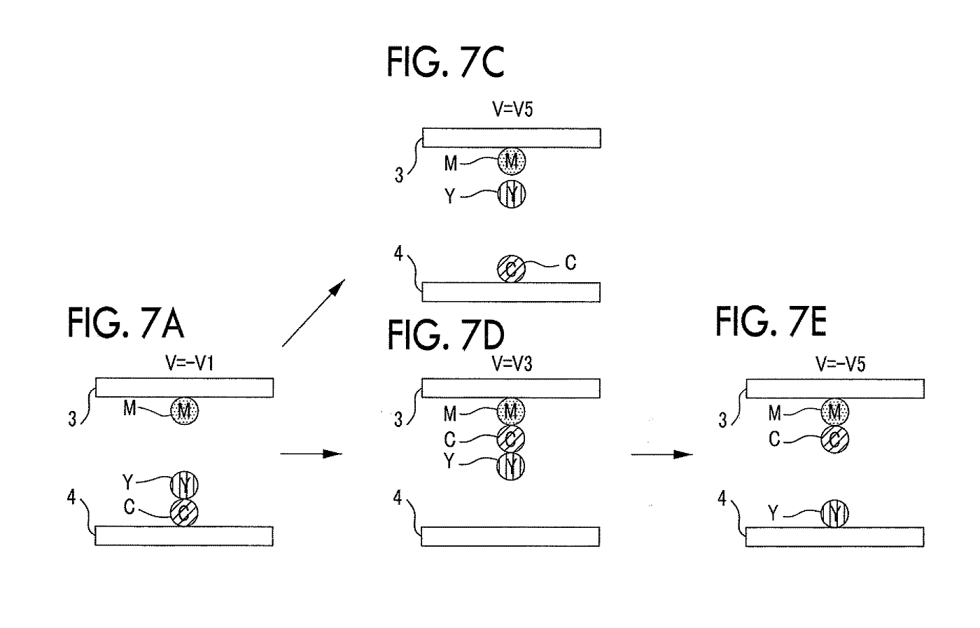

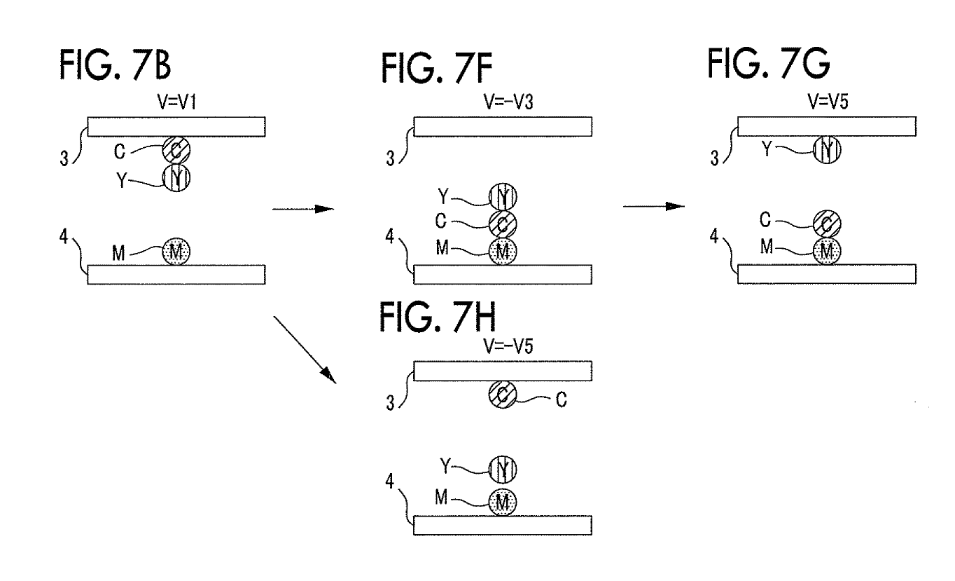

In FIGS. 7A to 7H, C, M and Y particles are respectively illustrated singly, but, in the exemplary embodiment, a single particle indicates a particle group thereof.

First, when the voltage applying unit 30 applies a voltage V (−V1) between the display side electrode 3 and the back surface side electrode 4 under the control of the controller 50, the magenta particle M charged with a negative polarity is moved to the display side electrode 3 side, and the yellow particle Y and the cyan particle C charged with a positive polarity are moved to the back surface side electrode 4. This leads to a state illustrated in FIG. 7A, and the magenta particle M colored in magenta is observed from the display substrate 1 side.

In addition, when the voltage applying unit 30 applies a voltage V (V5) between the display side electrode 3 and the back surface side electrode 4 under the control of the controller 50 in the state (magenta display state) illustrated in FIG. 7A, the yellow particle Y is moved to the display side electrode 3 side. This leads to a state where the magenta particle M and the yellow particle Y are observed from the display substrate 1 side as illustrated in FIG. 7C, and red which is a subtractive color mixture of magenta and yellow is displayed.

In addition, when the voltage applying unit 30 applies a voltage V (V3) between the display side electrode 3 and the back surface side electrode 4 under the control of the controller 50 in the state (magenta display state) illustrated in FIG. 7A, the cyan particle C and the yellow particle Y are moved to the display side electrode 3 side. This leads to a state where the magenta particle M, the cyan particle C, and the yellow particle Y are observed from the display substrate side as illustrated in FIG. 7D, and black which is a subtractive color mixture of magenta, cyan and yellow is displayed.

In addition, when the voltage applying unit 30 applies a voltage V (−V5) between the display side electrode 3 and the back surface side electrode 4 under the control of the controller 50 in the state (black display state) illustrated in FIG. 7D, the yellow particle Y is moved to the back surface side electrode 4 side. This leads to a state where the magenta particle M and the cyan particle C are observed from the display substrate 1 side as illustrated in FIG. 7E, and blue which is a subtractive color mixture of magenta and cyan is displayed.

On the other hand, when the voltage applying unit 30 applies a voltage V (V1) between the display side electrode 3 and the back surface side electrode 4 under the control of the controller 50, the cyan particle C and the yellow particle Y are moved to the display side electrode 3 side. In addition, the magenta particle M is moved to the back surface side electrode 4 side. This leads to a state where the cyan particle C and the yellow particle Y are observed from the display substrate 1 side as illustrated in FIG. 7B, and green which is a subtractive color mixture of cyan and yellow is displayed.

In addition, when the voltage applying unit 30 applies a voltage V (−V3) between the display side electrode 3 and the back surface side electrode 4 under the control of the controller 50 in the state (green display state) illustrated in FIG. 7B, the cyan particle C and the yellow particle Y are moved to the back surface side electrode 4 side. This leads to a state where the magenta particle M, the cyan particle C, and the yellow particle Y are moved to the back surface substrate 2 side as illustrated in FIG. 7F, and white is displayed by the white dispersion medium 6.

Further, when the voltage applying unit 30 applies a voltage V (V5) between the display side electrode 3 and the back surface side electrode 4 under the control of the controller 50 in the state (white display state) illustrated in FIG. 7F, the yellow particle Y is moved to the display side electrode 3 side. This leads to a state where the yellow particle Y is observed from the display substrate 1 side as illustrated in FIG. 7G, and yellow is displayed.

In addition, when the voltage applying unit 30 applies a voltage V (−V5) between the display side electrode 3 and the back surface side electrode 4 under the control of the controller 50 in the state (green display state) illustrated in FIG. 7B, the yellow particle Y is moved to the back surface side electrode 4 side. This leads to a state where the cyan particle C is observed from the display substrate 1 side as illustrated in FIG. 7H, and cyan is displayed.

In other words, in the exemplary embodiment, the magnitude of an applied voltage is controlled such that voltages are sequentially applied from a voltage of which an absolute value of the threshold value voltage for moving the particles is larger, and an image corresponding to image information is displayed by controlling the movement of each particle.

Here, a driving method in the related art of the image display apparatus configured in this way will be described in detail. For example, a description will be made of a case where a certain pixel A displays yellow (the state illustrated in FIG. 7G), and another pixel B displays blue (the state illustrated in FIG. 7E). In addition, here, it is assumed that all the particles may display the maximum densities with eight pulses.

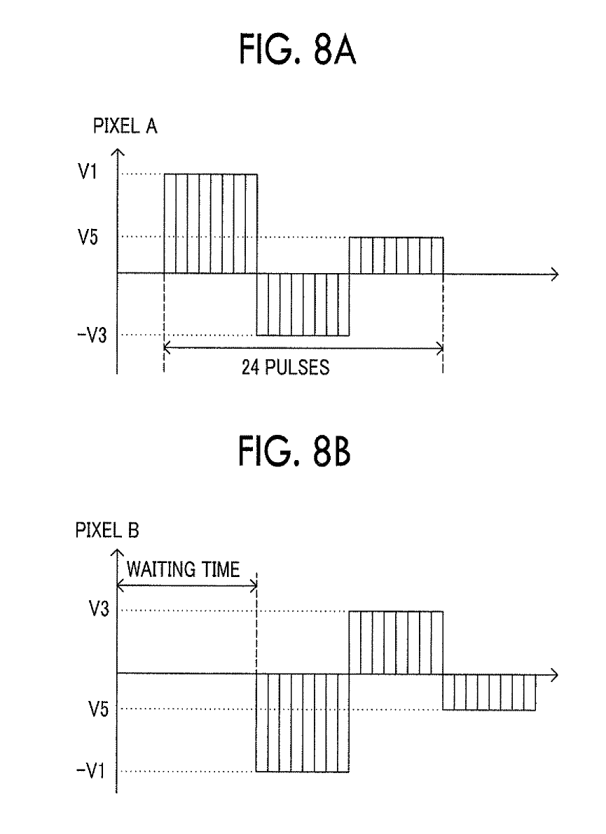

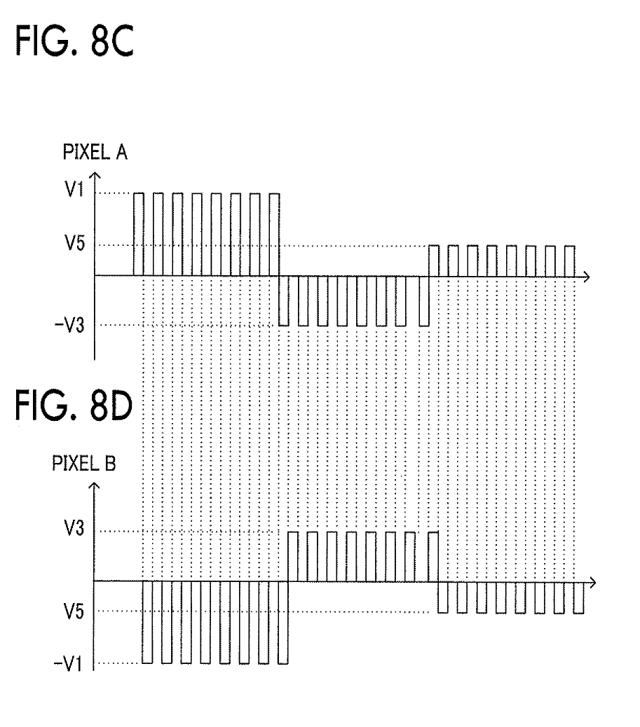

First, initially, a voltage with a positive polarity is applied to the entire screen (the back surface side electrode 4) through eight pulses. Whether or not the positive voltage is applied, and the magnitude of the applied voltage may be set for each pixel. In the example illustrated in FIGS. 8A to 8D, in the pixel A, as illustrated in FIG. 8A, a voltage V (+V1) is applied so as to move the magenta particle 14 to the back surface substrate 2 (FIG. 7B). In addition, in the pixel B, as illustrated in FIG. 8B, a voltage is not applied at this timing, and a waiting time arrives.

Next, a polarity is changed, and a voltage with a negative polarity is applied to the entire screen through eight pulses. In the pixel A, as illustrated in FIG. 8A, a voltage V (−V3) is applied so as to move the cyan particle C and the yellow particle Y to the back surface substrate 2 (FIG. 7F). In addition, in the pixel B, as illustrated in FIG. 8B, a voltage V (−V1) is applied so as to move the magenta particle M to the display substrate 1 (FIG. 7A). Here, since a certain color is displayed with respect to all the pixels, if an image is vaguely viewed at about four pulses which are a half of eight pulses, the image may be recognized at the timing when a density of the magenta particles of the pixel B substantially becomes a half, that is, at about twelve pulses.

Next, a polarity is changed again, and a voltage with a positive polarity is applied to the entire screen through eight pulses. In the pixel A, as illustrated in FIG. 8A, a voltage V (+V5) is applied so as to move the yellow particle Y to the display substrate 1 (FIG. 7G). In addition, in the pixel B, as illustrated in FIG. 8B, a voltage (+V3) is applied so as to move the cyan particle C and the yellow particle Y to the display substrate 1 (FIG. 7D). By this operation, yellow display in the pixel A is completed.

Next, a polarity is changed, and a voltage with a negative polarity is applied to the entire screen through eight pulses. In the pixel B, a voltage V (−V5) is applied so as to move the yellow particle Y to the back surface substrate 2 (FIG. 7E). By this operation, blue display in the pixel B is completed.

In other words, in the driving method in the related art, in the example of FIGS. 8A to 8D, a time of about twelve pulses is necessary in order to recognize an image.

Therefore, in the exemplary embodiment as well, it is possible to shorten the time until an image is recognized by employing the same driving method as in the first exemplary embodiment. In other words, a voltage polarity pattern where a polarity is reversed at a time width shorter than a pulse width of a colored particle of which the pulse width for displaying the maximum density is the shortest is generated, and the voltage applying unit 30 is controlled, such that a voltage with the same polarity of voltages of which polarities are reversed in the generated polarity pattern is continuously selected for each kind of colored particle, on the basis of information on each pixel of image information, and a voltage with the magnitude for driving is applied to each pixel for each kind of colored particle. Specifically, the controller 50 controls the scanning driver 26 and the data driver 28 of the voltage applying unit 30 such that a positive pulse voltage with a pulse width shorter than the pulse width for displaying the maximum density and a negative pulse voltage with the corresponding pulse width are alternately scanned, and the necessary number of pulse voltages is repeatedly applied until a density corresponding to image information arrives by controlling turning-on and turning-off of the thin film transistors 32 and sequentially changing the magnitude of an applied voltage.

For example, as illustrated in FIGS. 8C and 8D, in a case where the pixel A displays yellow and the pixel B displays blue, turning-on of the thin film transistor 32 of the pixel A (FIG. 8C) which displays yellow and application of a pulse voltage with a voltage V (V1), and turning-on of the thin film transistor 32 of the pixel B (FIG. 8D) which displays blue and application of a pulse voltage with a voltage V (−V1) are alternately repeated so as to apply the necessary number of pulse voltages until a density corresponding to image information arrives. Thereafter, turning-on of the thin film transistor 32 of the pixel which displays yellow and application of a pulse voltage with a voltage V (−V3), and turning-on of the thin film transistor 32 of the pixel which displays blue and application of a pulse voltage with a voltage V (V3) are alternately repeated so as to apply the necessary number of pulse voltages until a density corresponding to image information arrives. Next, turning-on of the thin film transistor 32 of the pixel which displays yellow and application of a pulse voltage with a voltage V (V5), and turning-on of the thin film transistor 32 of the pixel which displays blue and application of a pulse voltage with a voltage V (−V5) are alternately repeated so as to apply the necessary number of pulse voltages until a density corresponding to image information arrives. In other words, a voltage is applied to both the pixel A and the pixel B every other pulse. As above, control is performed such that a positive pulse voltage with a pulse width shorter than the pulse width for displaying the maximum density and a negative pulse voltage with the corresponding pulse width are alternately applied, the time until an image is recognized is shorter than in the related art in the same manner as the first exemplary embodiment. In the example of FIGS. 8C and 8D, it is expected that an image is recognized due to a movement of at least a certain particle to the eighth pulse with respect to all the pixels. In other words, even in an image which is not grasped only with the pixel A, display of the pixel B is performed substantially at the same time, thus a relative density variation appears, and thereby the time until the image is recognized becomes shorter than in the related art.

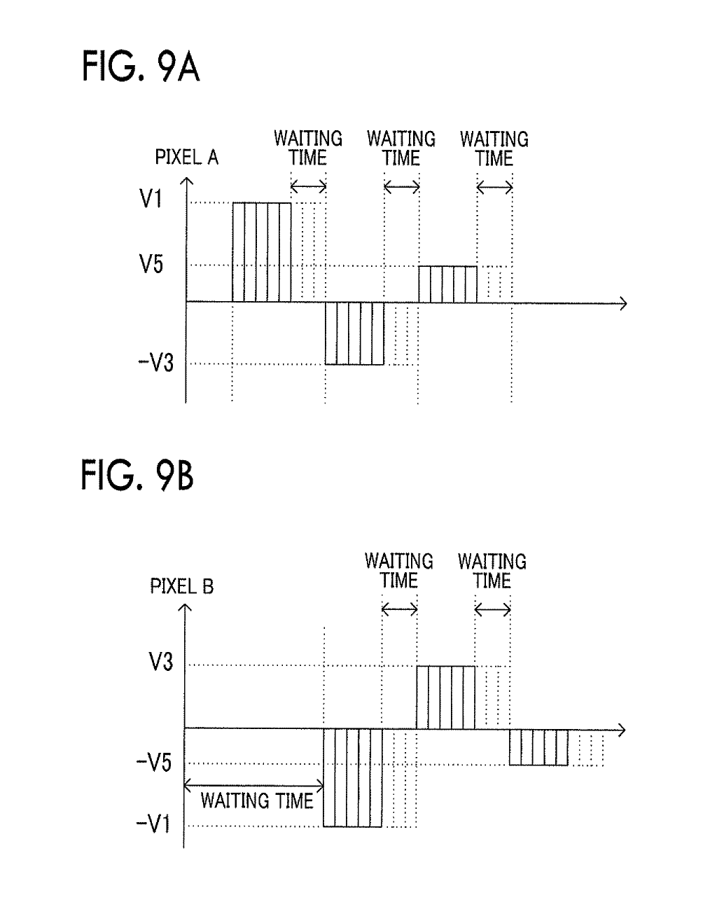

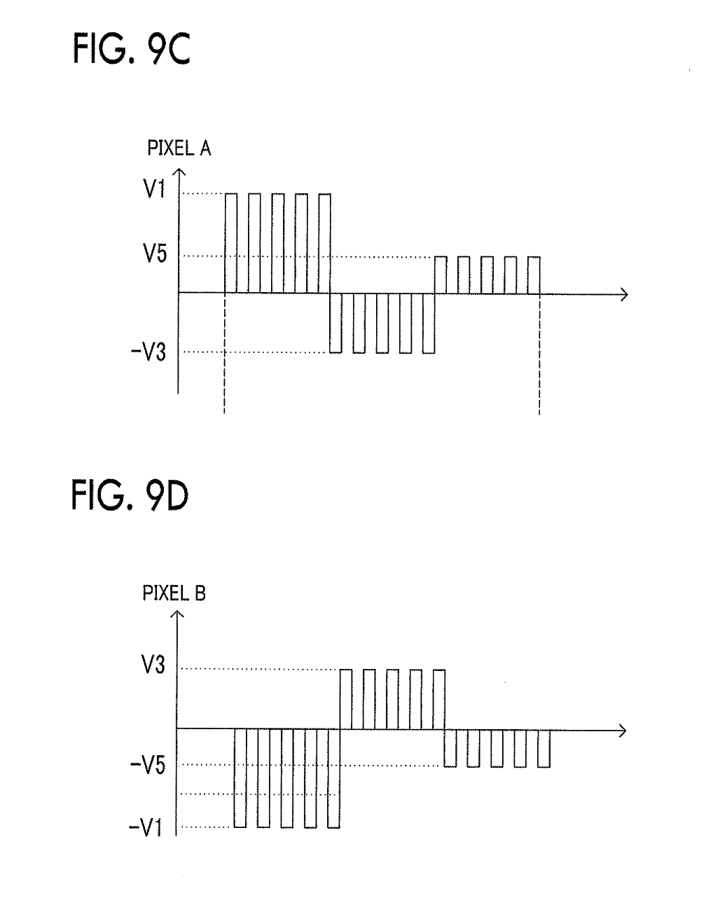

In addition, in the driving method in the related art, as described above, a voltage is applied while changing a polarity, and the necessary number of pulses is selected from time when a voltage with one polarity is applied so as to apply a voltage, but, in this case, if eight pulses are applied before a polarity is changed, when a certain pixel completes a density display with five pulses, the pixel is required to wait for a duration corresponding to three pulses. For example, as illustrated in FIGS. 8A and 8B, in a case where the number of pulses applied in each voltage is eight pulses, if the density display finishes when applied pulses in each voltage are five pulses, as illustrated in FIGS. 9A and 98, a duration corresponding to three pulses until changing to the next polarity is performed is a waiting time. However, in the exemplary embodiment, as illustrated in FIGS. 9C and 9D, a positive pulse voltage and a negative pulse voltage with a pulse width shorter than the pulse width for displaying the maximum density are alternately applied, and an operation of turning on the thin film transistors 32 in corresponding pixels is repeatedly performed. Therefore, finishing of applying the number of pulses necessary for displaying the maximum density is not awaited, and thus a display time is shortened accordingly.

In other words, with the driving as in the exemplary embodiment, a voltage with a positive polarity and a voltage with a negative polarity are alternately applied, and a voltage with the same polarity is applied at a different voltage value for each pixel. Thereby, a waiting time until a polarity is changed is shortened, and thus the timing when changing to a reverse polarity may be selected for each pixel and further a voltage with an appropriate magnitude may be applied. Since a waiting time is reduced as such, the time until an image is recognized becomes faster, and, it is expected that time until an image is practically displayed is reduced.

In addition, although a case where colored particles are of two types has been described in the first exemplary embodiment, and a case where colored particles are of three kinds has been described in the second exemplary embodiment, the kinds of particles may be four or more. For example, in the second exemplary embodiment, instead of coloring the dispersion medium, white particles which are not charged may be further included.

In addition, although a size of each colored particle has not been described particularly in each exemplary embodiment described above, the diameters of the particles may be the same or different.

In addition, in each exemplary embodiment described above, a process in the controllers 40 and 50 may be executed by hardware or a program of software. Further, the program may be stored on various recording media and be distributed.

Further, although, in each exemplary embodiment described above, the image display medium where plural colored particles are sealed has been described as an example, a display medium is not limited thereto, and, for example, an image display medium with a memory property using electrochromism or an image display medium using liquid crystal or the like with a memory property may be employed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A driving device of an image display medium which includes a plurality of kinds of colored particles having different charge characteristics for every kind and different colors for every kind for each pixel between a pair of substrates either of which has transparency and which displays an image by applying a voltage between the pair of substrates on the basis of image information,
the driving device comprising:
a voltage applying unit that applies a voltage between the substrates;
a generation unit that generates a polarity pattern in which a polarity is reversed at a time width shorter than a pulse width at which a colored particle, of which pulse width for displaying the maximum density is the shortest among the plurality of kinds of colored particles, displays the maximum density; and
a controller that controls the voltage applying unit such that a voltage with the magnitude for driving each kind of the colored particles is applied to each pixel, the voltage being a voltage with the same polarity continuously selected in the polarity pattern generated by the generation unit for each kind of colored particle, and the voltage with the same polarity being selected from voltages of which polarities are reversed in the polarity pattern on the basis of information on each pixel of the image information.

2. The driving device of the image display medium according to claim 1, wherein the controller controls the voltage applying unit such that after application of a first voltage V₁ with a magnitude for driving a first kind of colored particle of the plurality of kinds of colored particles is completed, a second voltage V₂ for driving a second kind of colored particle different from the first kind of colored particle, which has a polarity reverse to the first voltage and the relationship satisfying the following Expression with the first voltage, is applied to each pixel,

|V₁|≧|V₂|.

3. An image display apparatus comprising:
an image display medium that includes a plurality of kinds colored particles which are sealed between a pair of substrates at least one of which has transparency and have different charge characteristics and different colors for every kind for each pixel and displays an image by applying a voltage between the pair of substrates on the basis of image information; and
the driving device according to claim 1.

4. The driving device of the image display apparatus according to claim 3, wherein the controller controls the voltage applying unit such that after application of a first voltage V₁ with a magnitude for driving a first kind of colored particle of the colored particles is completed, a second voltage V₂ for driving a second kind of colored particle different from the first kind of colored particle, which has a polarity reverse to the first voltage and the relationship satisfying the following Expression with the first voltage, is applied to each pixel,

|V₁|≧|V₂|.

5. A driving method of an image display medium which includes a plurality of kind of colored particles having different charge characteristics for every kind and different colors for every kind for each pixel between a pair of substrates either of which has transparency and which displays an image by applying a voltage between the pair of substrates on the basis of image information,
the driving method comprising:
generating a polarity pattern in which a polarity is reversed at a time width shorter than a pulse width at which a colored particle, of which pulse width for displaying the maximum density is the shortest among the plurality of kinds of colored particles, displays the maximum density; and
performing control such that a voltage with the magnitude for driving each kind of the colored particles is applied to each pixel, the voltage being a voltage with the same polarity continuously selected in the polarity pattern generated by the generation unit for each kind of colored particle, and the voltage with the same polarity being selected from voltages of which polarities are reversed in the generated polarity pattern on the basis of information on each pixel of the image information.

6. The driving method of the image display medium according to claim 5, wherein, in the performing of the control, the control is performed such that after application of a first voltage V₁ with a magnitude for driving a first kind of colored particle of the colored particles is completed, a second voltage V₂ for driving a second kind of colored particle different from the first kind of colored particle, which has a polarity reverse to the first voltage and the relationship satisfying the following Expression with the first voltage, is applied to each pixel,

|V₁|≧|V₂|.

7. A non-transitory computer readable medium storing a driving program causing a computer to function as the generation unit and the controller of the driving device of the image display medium according to claim 1.

8. A non-transitory computer readable medium storing a driving program causing a computer to function as the generation unit and the controller of the driving device of the image display medium according to claim 2.
